(19) United States
(12) Patent Application Publication
(10) Pub. No.: US 2026/0023242 A1
(43) Pub. Date: Jan. 22, 2026

(54) OPTICAL SYSTEM AND AUGMENTED REALITY DEVICE

(71) Applicant: Goertek Optical Technology Co., Ltd., Shandong (CN)

(72) Inventor: YUN ZHAO, Shandong (CN)

(73) Assignee: Goertek Optical Technology Co., Ltd., Shandong (CN)

(21) Appl. No.: 18/995,256

(22) PCT Filed: Feb. 23, 2023
(86) PCT No.: PCT/CN2023/077822

§ 371 Date: Jan. 16, 2025

(30) Foreign Application Priority Data
Jul. 18, 2022 (CN) 202210844119.1

(51) Int. Cl. G02B 13/00; G02B 27/01

(52) U.S. Cl. CPC G02B 13/004; G02B 27/0172; G02B 27/0176; G02B 2027/0118; G02B 2027/0152

(57) ABSTRACT

Disclosed are an optical system and an augmented reality device. The optical system comprises sequentially from an object side to an image side: a stop, a lens group, and a display unit; the lens group comprises sequentially from the object side to the image side: a first lens, a second lens, a third lens, and a fourth lens; wherein each of the first lens, the second lens and the fourth lens has positive focal power, and the third lens has negative focal power; wherein the display unit has a maximum imaging circle diameter less than a diameter of the stop.

### CROSS-REFERENCE TO RELATED APPLICATIONS

The present disclosure is a National Stage of International Application No. PCT/CN2023/077822, filed on Feb. 23, 2023, which claims priority to Chinese Patent Application No. 202210844119.1, filed on Jul. 18, 2022, both of which are hereby incorporated by reference in their entireties.

### TECHNICAL FIELD

Embodiments of the present disclosure relate to the technical field of imaging display, and particularly to an optical system and an augmented reality device.

### BACKGROUND

With the development of computer technology, various wearable device products have emerged, with AR (Augmented Reality), VR (Virtual Reality), MR (Mediated Reality), XR and other devices receiving increasing attention. Among these, AR technology is a kind of technology that seamlessly integrates virtual information with the real world, it leverages diverse technical means such as multimedia, 3D modeling, real-time tracking and registration, intelligent interaction, and sensing to simulate and apply computer-generated content—such as text, images, three-dimensional models, music, video and other virtual information—to the real world. This integration “enhances” the real world by complementing it with virtual information.

As the demand for augmented reality devices grows, how to develop optical systems that offer high resolution, large relative aperture and miniaturization has become an urgent technical problem to be solved.

### SUMMARY

An objective of the present disclosure is to provide new technical solutions for an optical system and an augmented reality device, so as to solve at least one of the above technical problems.

In a first aspect, the present disclosure provides an optical system. The optical system sequentially includes from an object side to an image side: a stop, a lens group, and a display unit;
the lens group sequentially includes from the object side to the image side: a first lens, a second lens, a third lens, and a fourth lens; wherein the first lens, the second lens and the fourth lens have positive focal power, and the third lens has negative focal power;
wherein the display unit has a maximum imaging circle diameter less than a diameter of the stop.

Optionally, the maximum imaging circle diameter ranges from 3.1 mm to 3.3 mm, and the diameter of the stop ranges from 3.8 mm to 4.2 mm.

Optionally, the lens group includes a first lens provided closest to the stop, and an object-side surface of the first lens is spaced 0.1 mm to 0.4 mm from the stop along an optical axis.

Optionally, the optical system has a total effective focal length ranging from 5.8 mm to 6.1 mm.

Optionally, the first lens has an effective focal length ranging from 5.3 mm to 5.8 mm; the second lens has an effective focal length ranging from 8 mm to 8.5 mm; the third lens has an effective focal length ranging from-2.5 mm to-2 mm; the fourth lens has an effective focal length ranging from 3.8 mm to 4.3 mm.

Optionally, the optical system has an F number of 1.45 to 1.55.

Optionally, the first lens has an object-side surface which is convex, and an image-side surface which is concave, wherein a height at which light transmits to the object-side surface of the first lens is higher than a height at which light transmits to the image-side surface of the first lens; the second lens has an object-side surface which is convex, and an image-side surface which is concave, wherein a height at which light transmits to the object-side surface of the second lens is higher than a height at which light transmits to the image-side surface of the second lens.

Optionally, there is a first air gap between the first lens and the second lens, and the first air gap is less than 0.1 mm.

Optionally, there is a second air gap between the third lens and the fourth lens, and the second air gap is 1.73 mm to 1.78 mm, wherein the second air gap accounts for 23% to 25% of a total optical length of the optical system.

In a second aspect, an augmented reality device is provided. The augmented reality device includes a housing and the optical system according to the first aspect, and the optical system is accommodated within the housing.

According to embodiments of the present disclosure, the optical system provided herein comprises a lens group consisting of the first, second, third, and fourth lenses. By rationally allocating the focal power of each lens and defining the relationship between the maximum imaging circle diameter of the display unit and the diameter of the stop, the optical system achieves enhanced light throughput, improved image resolution, and reduced system weight.

Other features and advantages of the present disclosure will become apparent from the following detailed description of exemplary embodiments of the present disclosure with reference to the accompanying drawings.

### BRIEF DESCRIPTION OF THE DRAWINGS

The accompanying drawings incorporated in and constituting a part of the specification illustrate embodiments of present disclosure and together with the description thereof, serve to explain the principles of the disclosure.

FIG. 1 illustrates a structural schematic diagram of an optical system provided by an embodiment of the present disclosure.

FIG. 2 illustrates a schematic diagram of light paths of the optical system provided by an embodiment of the present disclosure.

FIG. 3 illustrates a relative illumination diagram of the optical system.

FIG. 4 illustrates a distortion diagram of the optical system.

FIG. 5 illustrates a modulation transfer function diagram of the optical system.

FIG. 6 illustrates a defocus curve graph of the optical system.

### DESCRIPTION OF REFERENCE SIGNS

1. display unit; 2. lens group; 21. first lens; 22. second lens; 23. third lens; 24. fourth lens; 3. stop.

### DETAILED DESCRIPTION

Various exemplary embodiments of the present disclosure will now be described in detail with reference to the accompanying drawings. It is to be noted that unless otherwise specified, the relative arrangements, numerical expressions and values of components and steps illustrated in the embodiments do not limit the scope of the present disclosure.

The description of at least one exemplary embodiment is for illustrative purpose only and in no way implies any restriction on the present disclosure, its application, or use.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Therefore, other examples of the exemplary embodiments may have different values.

It is to be noted that similar reference numbers and alphabetical letters represent similar items in the accompanying drawings. Once an item is defined in one drawing, further reference to it may be omitted in subsequent drawings.

The augmented reality device usually contains various components, such as a heat dissipation component, optical structure (optical machine), driver board LED, etc. The optical system of the present disclosure is part of the optical structure and provides an imaging light path for the optical structure. In the prior art, under the premise of ensuring basic functions of the augmented reality device, wearing comfort and high-quality imaging thereof are also particularly important, especially for AR glasses, where lightweight design significantly impacts enhancing user's experience.

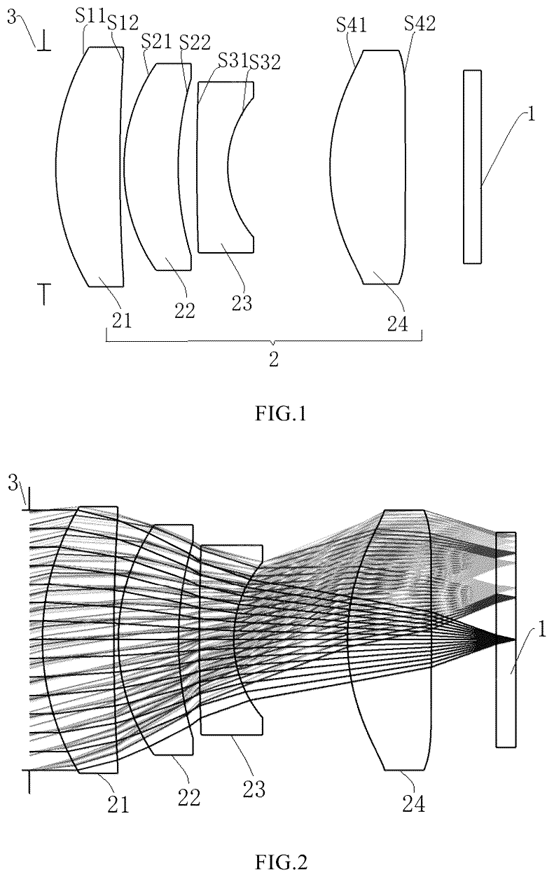

The first aspect of the embodiment of the present disclosure provides an optical system. As shown in FIGS. 1 and 2, the optical system sequentially comprises from an object side to an image side: a stop 3, a lens group 2, and a display unit 1.

The lens group 2 sequentially comprises from the object side to the image side: a first lens 21, a second lens 22, a third lens 23, and a fourth lens 24; wherein the first lens 21, the second lens 22 and the fourth lens 24 have positive focal power, and the third lens 23 has negative focal power. Here, the display unit 1 has a maximum imaging circle diameter less than a diameter of the stop 3.

Specifically, the optical system, from the object side to the image side, sequentially comprises the stop 3, the lens group 2 and the display unit 1. Specifically, light emitted from the display unit 1 (which is also the image source) sequentially passes through the lenses of lens group 2, that is, the light successively passes through the fourth lens 24, third lens 23, the second lens 22, and the first lens 21, before exiting the optical system from the stop 3. According to the light path reversibility principle, during the simulation and optimization of the optical system, light is incident into the stop 3 from the object side, and the light transmitted from the stop 3 sequentially passes through the lenses of the lens group 2, that is, the light sequentially passes through the first lens 21, the second lens 22, the third lens 23, and the fourth lens 24, before imaging on the display unit 1 (image plane). Here, the maximum imaging circle defined in the embodiment of the present disclosure refers to the maximum imaging circle imaged on the display unit 1, that is, the largest diameter of the image formed on the display unit 1 after light passes through the first lens 21, second lens 22, third lens 23, and fourth lens 24 according to the light reversibility. Here, the stop 3 may be an aperture stop 3.

In the present embodiment, the lens group 2 is composed of four lenses, with all four lenses sharing the same optical axis. The light beam emitted from the display unit 1 may sequentially pass through the fourth lens 24, third lens 23, second lens 22, and first lens 21 of the lens group 2, and ultimately is emergent from the stop 3.

Here, in the present embodiment, the focal power of the first lens 21 is positive, the focal power of the second lens 22 is positive, the focal power of the third lens 23 is negative, and the focal power of the fourth lens 24 is positive. By reasonably distributing the focal power of the first lens 21, the second lens 22, the third lens 23, and the fourth lens 24, it is possible to ensure the balance of aberrations in the optical system and to guarantee the resolution of the system.

Compared with prior art, the optical system in the present embodiment of the present disclosure contains four lenses, reducing the number of lenses and effectively lowers the total weight of the system. Moreover, the reduction in the number of lenses also, to some extent, reduces the volume of the optical system.

In the present embodiment, it is also specified that the maximum imaging circle diameter of the display unit 1 is less than the diameter of the stop 3, meaning that the diameter of the stop 3 is greater than the maximum imaging circle diameter. Specifically, the smaller the maximum imaging circle diameter, the narrower the field of view of the optical system, the shorter the effective focal length of the optical system, the larger the diameter of the stop 3, and the smaller the F-number of the optical system. When the F-number of the optical system is small, the light throughput of the optical system will be increased, thereby enhancing the resolution of the imaging picture and improving image quality during the imaging process.

Therefore, by rationally allocating the focal power of each lens and limiting the relationship between the maximum imaging circle diameter of the of the display unit 1 and the diameter of the stop 3, the optical system provided herein, whose lens group 2 consists of the first lens 21, second lens 22, third lens 23, and fourth lens 24, not only enhances the light throughput of the optical system, but also reduces the weight of the system while improving the resolution of the imaging picture of the optical system, thus enabling the optical system to meet the requirements on lightweight and miniaturized development.

In an optional embodiment, the system operates at a wavelength of 530±20 nm, which meets the imaging of the optical system.

In an embodiment, the maximum imaging circle diameter ranges from 3.1 mm to 3.3 mm, and the diameter of the stop 3 ranges from 3.8 mm to 4.2 mm.

In the present embodiment, the range of the maximum imaging circle diameter is also specified. During use, it ensures that all light emitted by the display unit 1 (image source) can be transmitted to the fourth lens 24. Here, the maximum imaging circle diameter affects the field angle of the optical system. The present embodiment defines the maximum imaging circle diameter within this range, and the system field angle of the optical system is from 28° to 32°. Additionally, the present embodiment defines the maximum imaging circle diameter within this range, and thus also limits the size of display unit 1 to a certain extent, such that size of display unit 1 does not have to be too large.

In the present embodiment, the range of the diameter of the stop 3 is defined, with its diameter being greater than the range of the maximum imaging circle diameter. This increases the light throughput of the optical system and improves the resolution of the imaging picture.

Specifically, the larger the diameter of the stop 3, the greater the light throughput of the optical system, which better improves the imaging picture. However, the larger the diameter of the stop 3, the higher the design complexity of the optical system, thereby making it challenging to reduce the volume and weight of the optical system. Therefore, the embodiment of the present disclosure limits the range of the diameter of the stop 3 within this range, as well as limits the maximum imaging circle diameter within this range, thus reducing the overall volume of the optical system and decreasing the overall weight of the optical system.

In an embodiment, as shown in FIGS. 1 and 2, the lens group 2 comprises a first lens 21 provided closest to the stop 3, and an object-side surface of the first lens 21 is spaced 0.1 mm to 0.4 mm from the stop 3 along an optical axis.

Specifically, in the embodiment of the present disclosure, the stop 3 is provided on one side of the lens group 2 farthest from the display unit 1, that is, by adopting a scheme of providing the stop 3 outward, the stop 3 is provided on one side of the first lens 21 proximate to the object-side surface. When the stop 3 is applied to the augmented reality device (for example, the AR optical machine), it is possible to ensure that the setting position of the stop 3 is placed together with the entrance pupil of the optical waveguide, and to ensure the optical efficiency of the augmented reality device while reducing the overall volume of the augmented reality device.

In the present embodiment, the distance between the object-side surface of the first lens 21 and the stop 3 along the optical axis is limited to 0.1 mm to 0.4 mm, which shortens the interval between the stop 3 and the lens group 2, thereby reducing the volume of the optical system. In addition, when the optical system is applied to the augmented reality device, the volume of the augmented reality device is also reduced. Optionally, the distance between the object-side surface of the first lens 21 and the stop 3 along the optical axis is 0.2 mm.

In an embodiment, the optical system has a total effective focal length ranging from 5.8 mm to 6.1 mm.

Specifically, the total effective focal length f of the optical system is related to the effective focal length of each lens itself and the distance and size between the optical components, and the effective focal length of each lens itself is influenced by the curvature radius and the thickness of each lens. In the present embodiment, by further limiting the total effective focal length of the system, a shorter total effective focal length of the optical system can be achieved, contributing to a reduction in the volume of the optical system.

In an embodiment, the first lens 21 has an effective focal length ranging from 5.3 mm to 5.8 mm; the second lens 22 has an effective focal length ranging from 8 mm to 8.5 mm; the third lens 23 has an effective focal length ranging from −2.5 mm to −2 mm; the fourth lens 24 has an effective focal length ranging from 3.8 mm to 4.3 mm.

In the present embodiment, by limiting the effective focal length of each lens, the first lens 21, the second lens 22 and the fourth lens 24 function to converge the light, while the third lens 23 functions to diverge the light. The present embodiment limits the effective focal length of each lens, so that the total effective focal length of the optical system meets the above ranges, thus achieving the purpose of reducing the volume of the optical system.

In an embodiment, the optical system has an F number of 1.45 to 1.55.

In the present embodiment, the F-number of the optical system is limited, wherein the F-number of the optical system is adjustable in the range of 1.45 to 1.55. Compared with the prior art, the F-number of the optical system ranges from 1.7 to 1.8, so that the present embodiment reduces the F-number of the optical system and improves the light throughout of the optical system.

In an embodiment, the first lens 21 has an object-side surface which is convex, and an image-side surface which is concave, wherein a height at which light transmits to the object-side surface of the first lens 21 is higher than a height at which light transmits to the image-side surface of the first lens 21;
the second lens 22 has an object-side surface which is convex, and an image-side surface which is concave, wherein a height at which light transmits to the object-side surface of the second lens 22 is higher than a height at which light transmits to the image-side surface of the second lens 22.

In the present embodiment, the face shape of the first lens 21 and the face shape of the second lens 22 are defined such that: the focal power of the first lens 21 is positive, the object-side surface S11 of the first lens 21 is convex, and the image-side surface S12 of the first lens 21 is concave. Therefore, the focal power of the object-side surface of the first lens 21 is positive, and the focal power of the image-side surface of the first lens 21 is negative.

Here, according to the light path reversible principle, the light is incident from the object side into the stop 3, and the light transmitted from the stop 3 is transmitted to the second lens 22 through the first lens 21. Specifically, the light transmitted from stop 3 first passes through the object-side surface S11 of the first lens 21, then through the image-side surface S12 of the first lens 21, before being transmitted to the second lens 22.

In the present embodiment, since the diameter of the stop 3 is greater than the maximum imaging circle diameter, following the light path reversible principle, the light transmitted from the object side is transmitted to lens group 2 through the stop 3, is required to be focused by the first lens 21 and the second lens 22, and is transmitted to the third lens 23 and the fourth lens 24 until it is transmitted to the display unit 1.

Specifically, referring to FIG. 2, the height at which the light is transmitted to the object-side surface S11 of the first lens 21 is higher than height at which the light is transmitted to the image-side surface S12 of the first lens 21. The higher the height of the light reaching the surface of the lens, the larger the corresponding focal power. Therefore, the object-side surface of the first lens 21 has a larger positive focal power while the image-side surface of the first lens 21 has a smaller negative focal power, and after the two are combined together, the focal power of the first lens 21 is positive. In a specific embodiment, the first lens 21 is a meniscus lens with a positive focal power.

Specifically, referring again to FIG. 2, the light is focused by the first lens 21 and then transmitted to the second lens 22. The height at which light is transmitted to the object-side surface S21 of the second lens 22 is greater than the height at which the light is transmitted to the image-side surface S22 of the second lens 22, wherein the higher the light reach the surface of the lens, the greater the corresponding focal power is. Therefore, the object-side surface S21 of the second lens 22 has a larger positive focal power while the image-side surface S22 of the second lens 22 has a smaller negative focal power, and after the two are combined together, the focal power of the second lens 22 is positive.

Thus, in the lens group 2, through the continuous focus of the light by the first lens 21 and the second lens 22, the size of the light spot is reduced.

Additionally, the reason why the focal power of the third lens 23 is negative is that the fourth lens 24, which is the last lens in front of the display unit 1, must have positive focal power to converge the light onto the display unit 1, and therefore for the balance of the focal power of the whole system, the focal power of the third lens 23 must be negative. otherwise the whole optical system would consist only of positive lenses, leading to unbalanced aberrations and potentially compromised image resolution.

In a specific embodiment, the object-side surface S31 of the third lens 23 is flat, the image-side surface S32 of the third lens 23 is concave, the object-side surface S41 of the fourth lens 24 is convex, and the image-side surface S42 of the fourth lens 24 is flat.

In a specific embodiment, the size of the light spot incident into the first lens 21 is larger than the size of the light spot emerging from the second lens 22.

Specifically, light is incident into the stop 3 from the object side, and the light transmitted from the stop 3 sequentially passes through the lenses of the lens group 2, that is, the light sequentially passes through the first lens 21, the second lens 22, the third lens 23, and the fourth lens 24, before imaging on the display unit 1 (herein, the display unit 1 is the image plane). Since the diameter of the stop 3 is larger than the maximum imaging surface diameter, the focal power of the first lens 21 is positive, and the focal power of the second lens 22 is positive, the first lens 21 and the second lens 22 focus the light and thus reduce the size of the spot. Thus, the size of the spot incident into the first lens 21 is larger than the size of the spot emergent from the second lens 22.

In an embodiment, there is a first air gap between the first lens 21 and the second lens 22, wherein the first air gap is less than 0.1 mm.

In the present embodiment, the air gap between the first lens 21 and the second lens 22 is limited, thereby reducing the total optical length of the optical system.

In an embodiment, there is a second air gap between the third lens 23 and the fourth lens 24, and the second air gap is 1.73 mm to 1.78 mm, wherein the second air gap accounts for 23% to 25% of a total optical length of the optical system.

In the present embodiment, the second air gap between the third lens 23 and the fourth lens 24 is limited, wherein by limiting the air gap between the third lens 23 and the fourth lens 24 to this range, it is possible to ensure that the light emitting from the third lens 23 has a sufficient distance to expand the size of the spot, so as to focus the light through the fourth lens 24 and thus to image on the display unit 1.

In an embodiment, the display unit 1 is a self-luminous component, for example, a self-luminous Micro-led chip.

Specifically, the present embodiment limits the type of the display unit 1, and omits the illumination part of the conventional AR optical machine, which greatly reduces the volume of the product. For example, the embodiment of the present disclosure may control the volume of the augmented reality device to be 0.3 cc (cubic centimeters), while the volume of the AR optical machine based on the DMD chip of the same level is generally 4 cc (cubic centimeters), and the volume of the AR optical machine based on the LCOS chip is generally 2.5 cc (cubic centimeters). Compared with the prior art, the embodiment of the present disclosure reduces the volume of the augmented reality device.

In a second aspect, an augmented reality device is provided. The augmented reality device comprises a housing and the optical system according to the first aspect, wherein the optical system is accommodated within the housing.

Specifically, the imaging light path of the augmented reality device in the present embodiment is provided by the optical system in the present disclosure. On the premise of ensuring that the augmented reality device has a good imaging effect, the present disclosure reduces the weight and volume of the entire augmented reality device, thereby improving the user's experience.

Optionally, an optical waveguide structure is included. In the use of the augmented reality device, the light is transmitted through the optical waveguide structure and reaches the human eye after being emitted from it.

The optical system provided by the embodiment of the present disclosure is specifically described below through five embodiments.

### First Embodiment

In the first embodiment, the optical parameters of the first lens 21, the second lens 22, the third lens 23 and the fourth lens 24 in the optical system are shown in Table 1.

| | | | Curvature | | Refractive | Abbe |
|---|---|---|---|---|---|---|
| | Type of | | radius | Thickness | index | number |
| Lens | lens | Surface | (mm) | (mm) | (Nd) | (Vd) |
| first | glass | S11 | 3.98 | 1.09 | 1.8 | 46.6 |
| lens 21 | sphere | S12 | 30.56 | 0.07 | | |
| | surface | | | | | |
| second | glass | S21 | 3.12 | 0.95 | 1.77 | 49.6 |
| lens 22 | sphere | S22 | 5.28 | 0.32 | | |
| | surface | | | | | |
| third | glass | S31 | 40.85 | 0.53 | 1.85 | 23.8 |
| lens 23 | sphere | S32 | 1.84 | 1.75 | | |
| | surface | | | | | |
| fourth | glass | S41 | 3.35 | 1.28 | | |
| lens 24 | aspheric | S42 | −113 | 0.99 | 1.81 | 41.1 |
| | surface | | | | | |

In the first embodiment, the refractive index of the third lens 23 is larger than that of the other lenses. The larger the refractive index is, the more severe the chromatic dispersion is, that is, the lower the Abbe number is. Therefore, the Abbe number of the third lens 23 is smaller than Abbe number of the other lenses.

Here, the effective focal length of the first lens 21 ranges from 5.3 mm to 5.8 mm; the effective focal length of the second lens 22 ranges from 8 mm to 8.5 mm; the effective focal length of the third lens 23 ranges from −2.5 mm to −2 mm; and the effective focal length of the fourth lens 24 ranges from 3.8 mm to 4.3 mm. The total effective focal length of the optical system ranges from 5.8 mm to 6.1 mm, the field angle of the optical system ranges from 28° to 32°, the system operates at a wavelength of 530±20 nm, and the maximum imaging circle diameter of the optical system ranges from 3.1 mm to 3.3 mm. The F-number of the optical system ranges from 1.45 to 1.55. The total optical length of the optical system is 6.98 mm.

Here the first lens 21, the second lens 22, and the third lens 23 are all glass spherical lenses, while the fourth lens 24 is a glass aspheric lens, so the first lens 21, the second lens 22, the third lens 23, and the fourth lens 24 are not sensitive to tolerances, and are also less influenced by temperature changes. Additionally, both the object-side surface S41 and the image-side surface S42 of the fourth lens 24 are aspheric.

Here, the aspheric parameters of the fourth lens 24 are shown in Table 2:

| Surface | CONIC | A2 | A3 | A4 | A5 |
|---|---|---|---|---|---|
| S41 | −0.89 | 1.79e−3 | 8.01e−4 | −7.65e−4 | 2.26e−4 |
| S42 | 8.96 | 4.98e−3 | −2.223e−3 | −1.08e−4 | −4.28e−6 |

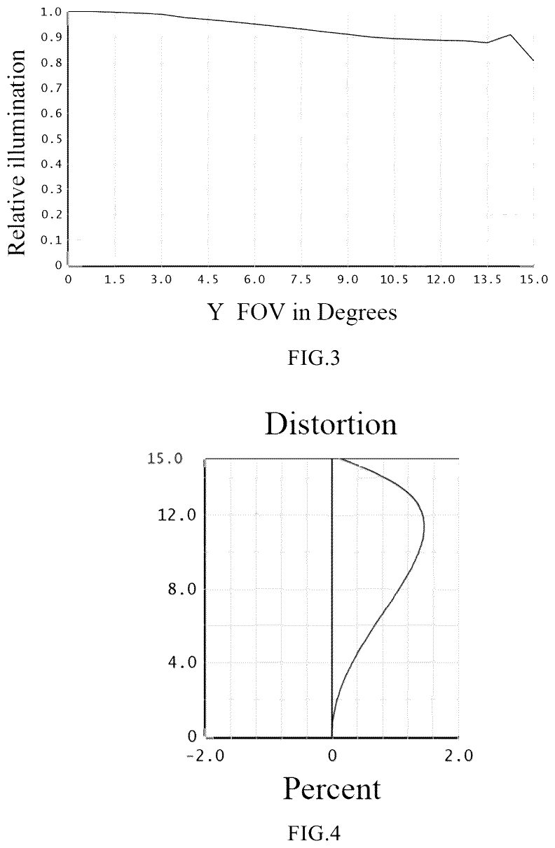

The parameters of each field of view of the above optical system, as obtained by measurement, are shown in FIG. 3 to FIG. 6.

Referring to FIG. 3, it illustrates the relative illumination diagram of the optical system, wherein the relative illumination refers to the ratio of the illuminance at various FOV positions on the display unit 1 (image plane) to the illuminance at the central field of view position. The higher the relative illumination, the better the imaging quality.

Referring to FIG. 4, it illustrates a distortion diagram of the optical system, with the maximum optical distortion across the entire field of view being less than 1.5%.

Referring to FIG. 5, it illustrates the modulation transfer function (MTF) graph of the optical system, wherein MTF indicates the relationship between modulation degree and the line pairs per millimeter within an image, which is used to evaluate the ability to reproduce fine details of a scene. In this embodiment, MTF values at all fields of view are greater than 6.

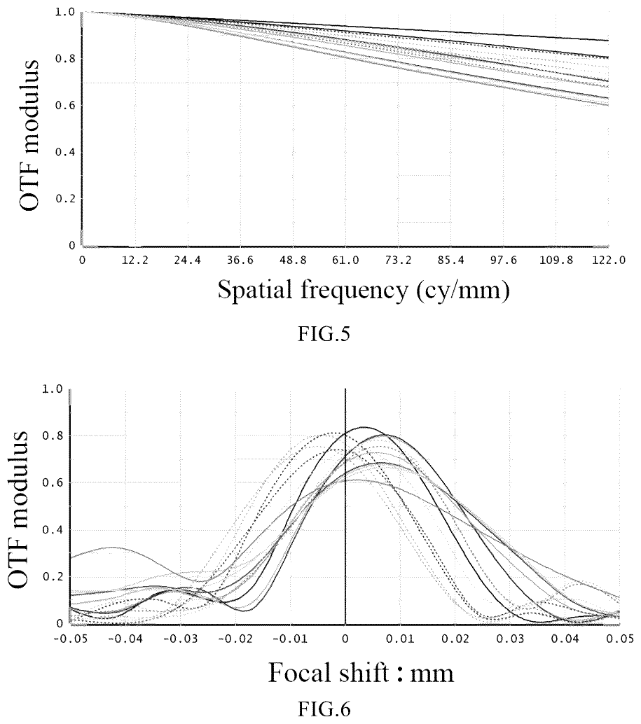

Referring to FIG. 6, it illustrates the defocus curve graph of the optical system. Here, the more the display unit 1 (image plane) deviates from the design value, the more the MTF drops

### Second Embodiment

In the second embodiment, the optical parameters of the first lens 21, second lens 22, third lens 23, and fourth lens 24 in the optical system are as shown in Table 3.

| | | | Curvature | | Refractive | Abbe |
|---|---|---|---|---|---|---|
| | Type of | | radius | Thickness | index | number |
| Lens | lens | Surface | (mm) | (mm) | (Nd) | (Vd) |
| first | glass | S11 | 3.93 | 1.06 | 1.8 | 46.6 |
| lens 21 | sphere | S12 | 32 | 0.07 | | |
| | surface | | | | | |
| second | glass | S21 | 3.1 | 0.89 | 1.77 | 49.6 |
| lens 22 | sphere | S22 | 4.75 | 0.32 | | |
| | surface | | | | | |
| third | glass | S31 | 38 | 0.49 | 1.85 | 23.8 |
| lens 23 | sphere | S32 | 1.92 | 1.69 | | |
| | surface | | | | | |
| fourth | glass | S41 | 3.68 | 1.36 | 1.81 | 41.1 |
| lens 24 | aspheric | S42 | −32.1 | 1.13 | | |
| | surface | | | | | |

In the second embodiment, the refractive index of the third lens 23 is greater than that of the other lenses. The larger the refractive index, the more severe the dispersion, that is, the lower the Abbe number is. Therefore, the Abbe number of the third lens 23 is smaller than Abbe number of the other lenses.

Here, the effective focal length of the first lens 21 ranges from 5.3 mm to 5.8 mm; the effective focal length of the second lens 22 ranges from 8 mm to 8.5 mm; the effective focal length of the third lens 23 ranges from −2.5 mm to −2 mm; and the effective focal length of the fourth lens 24 ranges from 3.8 mm to 4.3 mm. The total effective focal length of the optical system ranges from 5.8 mm to 6. 1 mm, with a field angle ranging from 28° to 32°. The system operates at a wavelength of 530±20 nm, and the maximum imaging circle diameter ranges from 3.1 mm to 3.3 mm. The F-number of the optical system ranges from 1.45 to 1.55. The overall optical length of the system is 7.01 mm.

Here, the first lens 21, second lens 22, and third lens 23 are all glass spherical lenses, while the fourth lens 24 is a glass aspheric lens. Thus, the first lens 21, second lens 22, third lens 23, and fourth lens 24 are not sensitive to tolerances, and are also less influenced by temperature changes. Additionally, both the object-side surface S41 and image-side surface S42 of the fourth lens 24 are aspheric.

Here the aspheric parameters of the fourth lens 24 are shown in Table 4:

| Surface | CONIC | A2 | A3 | A4 | A5 |
|---|---|---|---|---|---|
| S41 | −1.688 | −1.06e−3 | 3.43e−4 | −2.06e−4 | −7.15e−5 |
| S42 | 100 | −5.77e−4 | −2.63e−3 | 3.71e−4 | −1.78e−4 |

Here, the parameters of the optical system provided by the present embodiment satisfy the optical parameters shown in FIGS. 3 to 6, resulting in the small size, light weight and good imaging effect of the optical system.

### Third Embodiment

In the third embodiment, the optical parameters of the first lens 21, the second lens 22 the third lens 23 and the fourth lens 24 in the optical system are shown in Table 5.

| | | | Curvature | | Refractive | Abbe |
|---|---|---|---|---|---|---|
| | Type of | | radius | Thickness | index | number |
| Lens | lens | Surface | (mm) | (mm) | (Nd) | (Vd) |
| first | glass | S11 | 3.93 | 1.04 | 1.8 | 46.6 |
| lens 21 | sphere | S12 | 29 | 0.07 | | |
| | surface | | | | | |
| second | glass | S21 | 3.11 | 0.89 | 1.77 | 49.6 |
| lens 22 | sphere | S22 | 6.24 | 0.32 | | |
| | surface | | | | | |
| third | glass | S31 | −43.2 | 0.54 | 1.85 | 23.8 |
| lens 23 | sphere | S32 | 1.85 | 1.43 | | |
| | surface | | | | | |
| fourth | glass | S41 | 3.35 | 1.29 | 1.81 | 41.1 |
| lens 24 | aspheric | S42 | 282.15 | 1.46 | | |
| | surface | | | | | |

In the third embodiment, the refractive index of the third lens 23 is larger than that of the other lenses. The larger the refractive index is, the more severe the chromatic dispersion is, that is, the lower the Abbe number is. Therefore, the Abbe number of the third lens 23 is smaller than Abbe number of the other lenses.

The effective focal length of the first lens 21 ranges from 5.3 mm to 5.8 mm, the effective focal length of the second lens 22 ranges from 8 mm to 8.5 mm, and the effective focal length of the third lens 23 ranges from −2.5 mm to −2 mm, and the effective focal length of the fourth lens 24 ranges from 3.8 mm to 4.3 mm. The total effective focal length of the optical system ranges from 5.8 mm to 6.1 mm, the field angle of the optical system ranges from 28° to 32°, the system operates at a wavelength of 530±20 nm, and the maximum imaging circle diameter of the optical system ranges from 3.1 mm to 3.3 mm. The F-number of the optical system ranges from 1.45 to 1.55. The total optical length of the optical system is 7.04 mm.

Here, the first lens 21, the second lens 22, and the third lens 23 are all glass spherical lenses, while the fourth lens 24 is a glass aspheric lens. Therefore, the first lens 21, the second lens 22, the third lens 23, and the fourth lens 24 are not sensitive to tolerances, and are also less influenced by temperature changes. Both the object-side surface S41 and the image-side surface S42 of the fourth lens 24 are aspheric.

Here, the aspheric parameters of the fourth lens 24 are shown in Table 6:

| Surface | CONIC | A2 | A3 | A4 | A5 |
|---|---|---|---|---|---|
| S41 | −2.89 | −3.39e−3 | 4.31e−4 | 8.19e−5 | 5.94e−6 |
| S42 | 111.4 | −5.51e−3 | −2.66e−3 | 4.95e−4 | −1.39e−4 |

Here, the parameters of the optical system provided by the present embodiment satisfy the optical parameters shown in FIGS. 3 to 6, resulting in the small size, light weight and good imaging effect of the optical system.

### Fourth Embodiment

In the fourth embodiment, the optical parameters of the first lens 21, the second lens 22, the third lens 23 and the fourth lens 24 in the optical system are shown in Table 7.

| | | | Curvature | | Refractive | Abbe |
|---|---|---|---|---|---|---|
| | Type of | | radius | Thickness | index | number |
| Lens | lens | Surface | (mm) | (mm) | (Nd) | (Vd) |
| first | glass | S11 | 4.02 | 1.08 | 1.8 | 46.6 |
| lens 21 | sphere | S12 | 25.2 | 0.07 | | |
| | surface | | | | | |
| second | glass | S21 | 2.86 | 0.96 | 1.77 | 49.6 |
| lens 22 | sphere | S22 | 4.92 | 0.32 | | |
| | surface | | | | | |
| third | glass | S31 | 16.54 | 0.47 | 1.85 | 23.8 |
| lens 23 | sphere | S32 | 1.68 | 1.5 | | |
| | surface | | | | | |
| fourth | glass | S41 | 3.12 | 1.86 | 1.64 | 23.5 |
| lens 24 | aspheric | S42 | −34.1 | 0.57 | | |
| | surface | | | | | |

In the fourth embodiment, the refractive index of the third lens 23 is greater than that of the other lenses, and the larger the refractive index is, the greater the dispersion is, that is, the lower the Abbe number is. However, because the material of the fourth lens 24 is different from that of the first lens 21, the second lens 22 and the third lens 23, the Abbe number of the third lens 23 is smaller than the Abbe number of the first lens 21 and the second lens 22, and is slightly larger than the Abbe number of the fourth lens 24.

Here the effective focal length of the first lens 21 ranges from 5.3 mm to 5.8 mm, the effective focal length of the second lens 22 ranges from 8 mm to 8.5 mm, the effective focal length of the third lens 23 ranges from −2.5 mm to −2 mm, and the effective focal length of the fourth lens 24 ranges from 3.8 mm to 4.3 mm. The total effective focal length of the optical system ranges from 5.8 mm to 6.1 mm, the field angle of the optical system ranges from 28° to 32°, the system operates at a wavelength of 530±20 nm, and the maximum imaging circle diameter of the optical system ranges from 3.1 mm to 3.3 mm. The F number of the optical system ranges from 1.45 to 1.55, and the total optical length of the optical system is 6.83 mm.

Here, the first lens 21, the second lens 22 and the third lens 23 are glass spherical lenses, while the fourth lens 24 is a plastic aspheric lens, so that the cost of the optical system is reduced, and the total optical length of the optical system is shorter. In addition, the object-side surface S41 and the image-side surface S42 of the fourth lens 24 are aspheric.

Here, the aspheric parameters of the fourth lens 24 are shown in Table 8:

| Lens | CONIC | A2 | A3 | A4 | A5 |
|---|---|---|---|---|---|
| S41 | −0.43 | −4.33e−3 | −7.93e−4 | 5.16e−4 | −1.65e−4 |
| S42 | −100 | 1.93e−3 | −8.12e−3 | 1.33e−3 | −1.86e−4 |

Here, the parameters of the optical system provided by the present embodiment satisfy the optical parameters shown in FIGS. 3 to 6, resulting in the small size, light weight and good imaging effect of the optical system.

### Fifth Embodiment

In the fifth embodiment, the optical parameters of the first lens 21, the second lens 22, the third lens 23 and the fourth lens 24 in the optical system are shown in Table 9.

| | | | Curvature | | Refractive | Abbe |
|---|---|---|---|---|---|---|
| | Type of | | radius | Thickness | index | number |
| Lens | lens | Surface | (mm) | (mm) | (Nd) | (Vd) |
| first | glass | S11 | 4.02 | 1.08 | 1.8 | 46.6 |
| lens 21 | sphere | S12 | 25 | 0.07 | | |
| | surface | | | | | |
| second | glass | S21 | 2.86 | 0.96 | 1.77 | 49.6 |
| lens 22 | sphere | S22 | 4.95 | 0.32 | | |
| | surface | | | | | |
| third | glass | S31 | 16.6 | 0.47 | 1.85 | 23.8 |
| lens 23 | sphere | S32 | 1.68 | 1.49 | | |
| | surface | | | | | |
| fourth | glass | S41 | 3.11 | 1.85 | 1.64 | 23.5 |
| lens 24 | aspheric | S42 | −36 | 0.56 | | |
| | surface | | | | | |

In the fifth embodiment, the refractive index of the third lens 23 is greater than that of the other lenses, and the larger the refractive index is, the greater the dispersion is, that is, the lower the Abbe number is. However, because the material of the fourth lens 24 is different from that of the first lens 21, the second lens 22 and the third lens 23, the Abbe number of the third lens 23 is smaller than the Abbe number of the first lens 21 and the second lens 22, and is slightly larger than the Abbe number of the fourth lens 24.

Here, the effective focal length of the first lens 21 ranges from 5.3 mm to 5.8 mm, the effective focal length of the second lens 22 ranges from 8 mm to 8.5 mm, the effective focal length of the third lens 23 ranges from −2.5 mm to −2 mm, and the effective focal length of the fourth lens 24 ranges from 3.8 mm to 4.3 mm. The total effective focal length of the optical system ranges from 5.8 mm to 6.1 mm, the field angle of the optical system ranges from 28° to 32°, the system operates at a wavelength of 530±20 nm, and the maximum imaging circle diameter of the optical system ranges from 3.1 mm to 3.3 mm. The F number of the optical system ranges from 1.45 to 1.55, and the total optical length of the optical system is 6.80 mm.

Here, the first lens 21, the second lens 22 and the third lens 23 are all glass spherical lenses, while the fourth lens 24 is a plastic aspheric lens, so that the cost of the optical system is reduced, and the total optical length of the optical system is shorter. In addition, the object-side surface S41 and the image-side surface S42 of the fourth lens 24 are aspheric.

Here, the aspheric parameters of the fourth lens 24 are shown in Table 10:

| Lens | CONIC | A2 | A3 | A4 | A5 |
|---|---|---|---|---|---|
| S41 | −0.44 | −4.39e−3 | −7.68e−4 | 5.11e−4 | −1.654 |
| S42 | −92.42 | 1.88e−3 | −8.15e−3 | 1.33e−3 | −1.85e−4 |

Here, the parameters of the optical system provided by the present embodiment satisfy the optical parameters shown in FIGS. 3 to 6, resulting in the small size, light weight and good imaging effect of the optical system.

The above embodiments focus on the differences between the various embodiments, and the different optimization features between the various embodiments, as long as they do not contradict each other, may be combined to form a better embodiment, which will not be repeated herein taking into account the brevity of the text.

Although some specific embodiments of the present disclosure have been described in detail through examples, those skilled in the art should understand that the above examples are for illustration only and are not intended to limit the scope of the present disclosure. Those skilled in the art should understand that the above embodiments can be modified without departing from the scope and spirit of the present disclosure. The scope of the present disclosure is defined by the accompanying claims.

1. An optical system, comprising sequentially from an object side to an image side:
a stop,
a lens group comprising sequentially from the object side to the image side: a first lens, a second lens, a third lens, and a fourth lens, and
a display unit,
wherein each of the first lens, the second lens, and the fourth lens has a respective positive focal power, and the third lens has a negative focal power, and
wherein the display unit has a maximum imaging circle diameter less than a diameter of the stop.

2. The optical system according to claim 1, wherein the maximum imaging circle diameter ranges from 3.1 mm to 3.3 mm, and the diameter of the stop ranges from 3.8 mm to 4.2 mm.

3. The optical system according to claim 1, wherein the first lens is provided proximate to the stop, and has an object-side surface thereof spaced 0.1 mm to 0.4 mm from the stop along an optical axis.

4. The optical system according to claim 1, wherein the optical system has a total effective focal length ranging from 5.8 mm to 6.1 mm.

5. The optical system according to claim 1, wherein the first lens has an effective focal length ranging from 5.3 mm to 5.8 mm; the second lens has an effective focal length ranging from 8 mm to 8.5 mm; the third lens has an effective focal length ranging from −2.5 mm to −2 mm; the fourth lens has an effective focal length ranging from 3.8 mm to 4.3 mm.

6. The optical system according to claim 1, wherein the optical system has an F number from 1.45 to 1.55.

7. The optical system according to claim 1, wherein the first lens has convex object-side surface and a concave image-side surface, wherein a first height at which light transmits to the object-side surface of the first lens is higher than a second height at which light transmits to the image-side surface of the first lens;
the second lens has a convex object-side surface and a concave image-side surface, wherein a third height at which light transmits to the object-side surface of the second lens is higher than a fourth height at which light transmits to the image-side surface of the second lens.

8. The optical system according to claim 1, further comprises a first air gap between the first lens and the second lens, wherein the first air gap has a width less than 0.1 mm.

9. The optical system according to claim 1, further comprises a second air gap between the third lens and the fourth lens, wherein the second air gap has a width ranging from 1.73 mm to 1.78 mm, wherein the width of the second air gap accounts for 23% to 25% of a total optical length of the optical system.

10. The optical system according to claim 1, wherein the display unit comprises a Micro-LED chip.

11. An augmented reality device, comprises a housing and an optical system according to claim 1, wherein the optical system is accommodated within the housing.
